(19) United States
(12) Patent Application Publication
(10) Pub. No.: US 2005/0141018 A1
(43) Pub. Date: Jun. 30, 2005

(54) Network printer control system and data reception control method thereof

(76) Inventors: Seung-soo Oak, Seongnam-si (KR); Jin-hyung Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/914,309

(22) Filed: Aug. 10, 2004

(30) Foreign Application Priority Data
Dec. 29, 2003 (KR) 2003-98713

(51) Int. Cl. G06F 15/00

(52) U.S. Cl. 358/1.15

(57) ABSTRACT

A network printer control system having at least one terminal and a network printer communicably connected to the terminal, and a data reception control method thereof. The network printer control system includes a communication module for transmitting and receiving data to and from the respective terminal through a wire or wireless network, and a central operation part. The central operation part controls the communication module to limit reception of packets that satisfy a specified condition among data packets provided from the respective terminal to the network printer during a printing job of the network printer according to a request from the terminal. The network printer at limits the reception of a broadcast packet and a multicast packet that are not directly related to the print job of the network printer.

### CROSS-REFERENCE TO RELATED APPLICATIONS

This application claims the benefit under 35 U.S.C. § 119(a) from Korean Patent Application No. 2003-98713, filed on Dec. 29, 2003, the entire content of which is incorporated herein by reference.

### BACKGROUND OF THE INVENTION

1. Field of the Invention

The present invention relates to a network printer control system and a data reception control method thereof. More particularly, present invention relates to a network printer control system and a data reception control method thereof which can improve the work efficiency of a network printer and reduce malfunctions of the network printer by limiting the reception of broadcast packets and multicast packets that are not directly related to the current print job while the network printer is printing.

2. Description of the Related Art

By networking a computer and sharing software or database, an efficient use of the computer is sought and a remote use of a large-scaled computer becomes possible. As the computer is introduced to diverse types of businesses and the contents of the businesses are shared as described above, the networking of a computer environment becomes a necessity.

Particularly, in an office environment, computers and peripheral devices such as printers, scanners, copiers, facsimile machines, and so on, are connected in a Local Area Network (LAN) to form a network, and many users can share and use the peripheral devices.

FIG. 1 is a diagram illustrating a network printer system in which a network printer for a peripheral device and a plurality of computers are connected together through a wireless or wire communication network. In FIG. 1, the plurality of computers 120 and the network printer 110 are connected via a hub 130 which makes data transmission and reception between the components possible. The hub 130 is connected to a router 135 for communicating with the LAN or an external network such as the Internet. The router 135 reads the address of a destination (e.g., target) that is included in a packet and transmits the packet to another communication network through the most pertinent communication path during the transmission and reception of data.

Meanwhile, in the network printer 110, a network card is installed (not shown) to communicate with the computer 120. A simplified network printer system can be achieved by integrating the function of the network card onto a board of the network printer 10.

The network printer 110, as shown in FIG. 2, has a central operation part 11 1 for controlling the entire operation of the network printer 110, a Read Only Memory (ROM) 112 for storing a program required for a network operation and a network protocol for data transmission and reception, a Random Access Memory (RAM) 113 for temporarily storing transmitted and received data and internal data, a NonVolatile (NV) RAM 115 that is a flash memory, a communication module 116 for transmitting and receiving data through a wire or wireless network, and an input/output interface 114 for interfacing the data transmitted and received between the central operation part 111 and the network.

In the case of an internal type input/output interface 114, a Protocol Control Information (PCI), Industry Standard Architecture (ISA) or shared memory system may be used, and in the case of an external type input/output interface 114, an IEEE1284 or Universal Serial Bus (USB) system may be used.

The communication module 116 comprises a Medium Access Control (MAC) controller 117 and a physical layer (PHY) 118. The PHY 118 converts an external LAN signal to a signal compatible with the computer 120. The communication module 116 stores registered buffers for storing data transmitted and received through the network, network connection modes, and MAC addresses, broadcast addresses and multicast addresses to be received in the system.

Meanwhile, in each computer 120 communicably connected to the network printer 110, a network card 121 is mounted for communication with the network printer 110.

The printing process in the network printer system as described above will be explained with reference to FIGS. 3 to 5.

First, a user, who intends to use the network printer 110, must register and set a port of the network printer 110 in the computer 120. In this case, information being registered includes an Internet Protocol (IP) address of the network printer 110, a port number, etc. The information may further include a name of the network printer, a MAC address of the network printer, position information, and so on, in accordance with its implementation method.

If the user prepares a document using an application program 122 and selects a print command after the network printer is registered at step S410, the document is converted into printing data through a printer driver 123, and then is transferred to a spooler 124. The printing data passes through a port monitor 125, and then is transmitted to the network printer 110 using the network protocol.

If the printing process is performed by the application program 122, the port monitor 125 collects information on an IP address and so on by confirming registered information of the set port, and checks whether the corresponding IP address exists in an Address Resolution Protocol (ARP) cache table at step S420.

Generally, a data link such as an Ethernet or a token ring has an inherent addressing method that is different from the IP. For this reason, the network system requires a protocol for mapping an IP address such as the ARP on a MAC address that is a physical hardware address. The ARP cache table temporarily stores the IP address and the MAC address mapped by the ARP, and updates at predetermined intervals or whenever the ARP packet is received. Accordingly, if there is no packet transmission and reception through a certain IP address, or if a predetermined time elapses after the packet transmission and reception, it indicates that the MAC address corresponding to the IP address does not exist in the ARP cache table.

If the MAC address corresponding to the IP address of the network printer 110 does not exist in the ARP cache table at step S430, the ARP constructs a request packet, and then transmits the data to the MAC address of the network printer 110 by connecting to a Transmission Control Protocol/Internet Protocol (TCP/IP).

Meanwhile, if the MAC address corresponding to the IP address of the network printer 110 does not exist in the ARP cache table at step S430, the ARP requests that the TCP connect to the corresponding IP address at step S431. Then, the TCP transmits the connection request packet to the IP address of the network printer 110 using an IP datagram, and if the corresponding IP address exists on the directly connected network, the IP datagram is directly transmitted to the network printer 110. The network printer 110 provides a response packet with respect to the connection request packet of the ARP at step S432, and the computer 120, which has received the response packet, updates the MAC address of the network printer 110 obtained through the response packet in the ARP cache table at step S433. Thereafter, the computer 120 connects to the TCP/IP, and transmits the printing data to the network printer 110 at steps S440 and S450.

The network printer 110, which has received the printing data, as shown in FIG. 5, waits for the reception of the printing data at step S510, and if the printing is requested, the network printer 110 receives the printing data from the computer 120 at step S520 to output the data at step S530.

In the network printer system as described above, if various types of packets are provided through the network, the network printer 110 determines whether to receive and process the corresponding packets. At this time, whether to receive and process the corresponding packets is determined according to the MAC addresses of the corresponding packets.

Typically, when using the TCP/IP as the communication protocol, in order for one terminal to communicate with another terminal, the MAC address that is a physical address must be received in addition to the IP address that is a logical address. Thus, the respective terminal broadcasts the ARP request packet in order to receive the MAC address of the opposite terminal. Also, even in the case of using a moving IP, the respective terminal generally broadcasts at predetermined intervals in order to receive the position of the server or its own position in the network. Meanwhile, the multicast packet is used to share the information in a predetermined group and to transmit and receive the information, and if using an Apple Talk as the communication protocol, the multicast packet is frequently used for the data transmission and reception.

The broadcast packet and the multicast packet as described above increases as the number of terminals connected to the network becomes larger, and in practice, most packets transmitted and received through the terminal are broadcast packets or the multicast packets. A lot of time is used for receiving and processing the broadcast packet and the multicast packet, but the packets may unrelated to the work currently being performed in the terminal.

Nevertheless, the conventional system must receive and process various types of packets such as the broadcast packet or the multicast packet that is unrelated to the print job currently being printed by the network. Since the broadcast packet or the multicast packet requires the use of the memory and the central operation part 111, the speed of the printing operation is reduced, and in a severe case, an error may occur. Particularly, in performing printing that requires a real-time data processing, the reduced printing speed and the error occurrence may reduce the efficiency of the network printer system.

As described above, the conventional network printer system has problems in that it must process packets unrelated to the print job such as the broadcast packets or the multicast packets in addition to unicast packets, and this causes the efficiency of the whole network printer system to deteriorate and malfunctions to occur.

### SUMMARY OF THE INVENTION

The present invention has been developed in order to solve the above drawbacks and other problems associated with the conventional arrangement. An aspect of the present invention is to provide a network printer control system and a data reception control method thereof which can improve the work efficiency of a network printer and prevent the malfunction of the network printer by limiting the reception of data that are not directly related to a printing job of the network printer while the network printer performs the printing job.

The foregoing and other objects and advantages are substantially realized by providing a network printer control system having at least one terminal and a network printer communicably connected to the terminal. The system comprises a communication module for transmitting and receiving data to and from the respective terminal through a wire or wireless network, and a central operation part for controlling the communication module to limit reception of packets that satisfy a specified condition among data packets provided from the respective terminal to the network printer during a printing job of the network printer according to a request from the terminal.

It is preferable that the central operation part controls the communication module so as to limit reception of at least one of a multicast packet and a broadcast packet transmitted from the respective terminal during the printing job.

It is preferable that the communication module includes a Medium Access Control (MAC) controller for controlling the multicast packet and the broadcast packet transmitted to and received from the respective terminal.

The central operation part can broadcast operation state information on whether the network printer is performing the printing job for the respective terminal at predetermined intervals.

The central operation part, if the printing job is completed, can indicate completion of the printing job to the respective terminal, and release the receiving limit of the broadcast packet and the multicast packet by resetting the MAC controller.

It is preferable that the terminal is provided with a printer monitoring program for monitoring whether the operation state information is provided from the network printer.

It is also preferable that the printer monitoring program updates an address resolution protocol (ARP) cache table by extracting a MAC address and an Internet Protocol (IP) address of the network printer from the operation state information provided from the network printer.

In another aspect of the present invention, there is provided a data reception control method in a network printer control system including at least one terminal, a communication module for transmitting and receiving data to and from the respective terminal through a wire or wireless network, and a network printer having a central operation part for controlling the communication module and an operation of the system. The method comprises detecting whether the terminal requests a job to the network printer, if the terminal requests the job, performing the job by operating the network printer, and setting the communication module so as to limit reception of packets that satisfy a specified condition among data packets provided from the terminal to the network printer.

It is preferable that the step of limiting the reception of the packets comprises a step of limiting the reception of at least one of a multicast packet and a broadcast packet transmitted to the network printer.

The data reception control method according to the present invention may further comprise the step of providing operation state information on whether the network printer is performing the printing job to the terminal at predetermined intervals.

It is preferable that the data reception control method according to the present invention further comprises the steps of, if the job of the network printer is completed, informing completion of the job of the network computer to the respective terminal, and controlling the communication module so as to release the receiving limit of the broadcast packet and the multicast packet.

It is preferable that the data reception control method further comprises the step of the monitor monitoring whether the operation state information is provided from the network printer.

It is also preferable that the data reception control method according to the present invention further comprises the step of updating a MAC address and an IP address of the network printer included in the operation state information provided from the network printer in an address resolution protocol (ARP) cache table of the terminal.

### BRIEF DESCRIPTION OF THE DRAWINGS

The above aspects and features of the present invention will be more apparent by describing certain embodiments of the present invention with reference to the accompanying drawings, in which:

FIG. 1 is a diagram illustrating an example of a conventional network printer system;

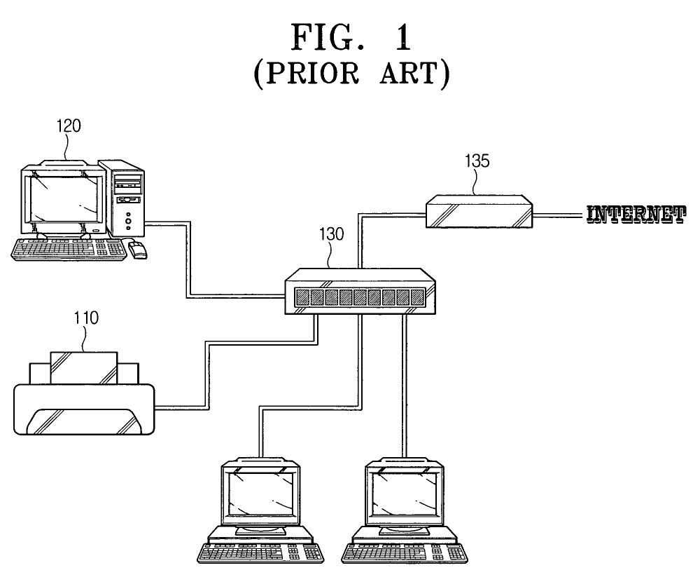

FIG. 2 is a block diagram illustrating the construction of a conventional network printer system;

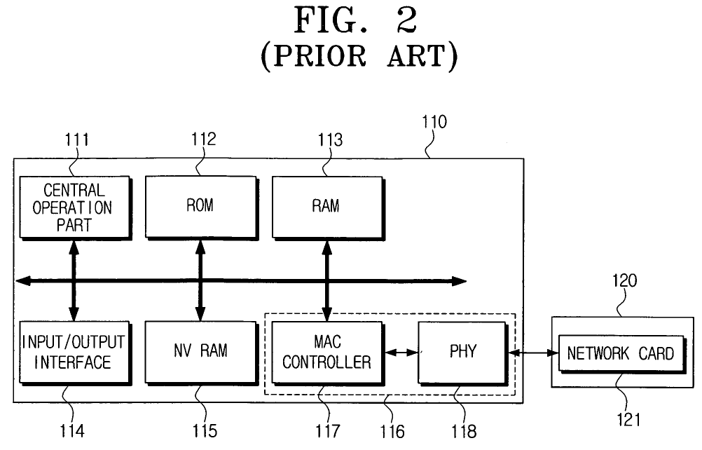

1 FIG. 3 is a block diagram illustrating a printing process in a computer of the network printer system of FIG. 2;

FIG. 4 is a flowchart illustrating a printing process in a computer of the network printer system of FIG. 2;

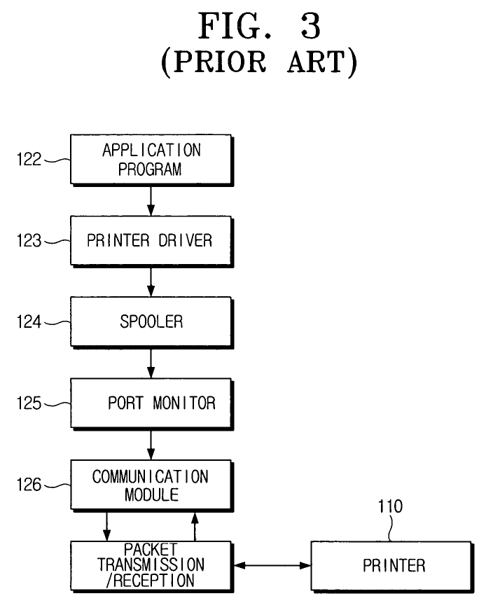

FIG. 5 is a flowchart illustrating a printing process in a printer of the network printer system of FIG. 2;

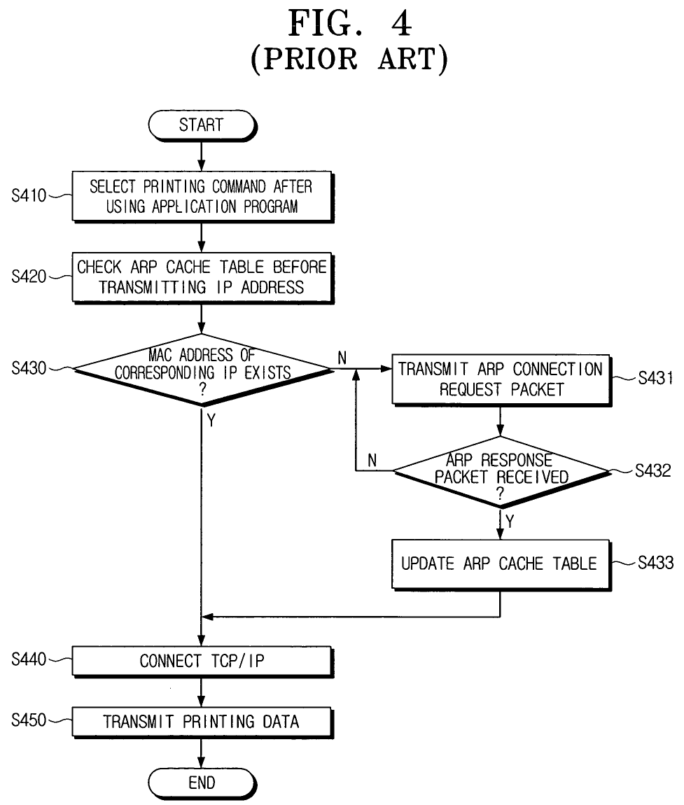

FIG. 6 is a block diagram illustrating the construction of a network printer control system according to an embodiment of the present invention;

FIG. 7 is a diagram illustrating the structure of a packet formed by ARP when an address of a terminal is requested and responded through a network;

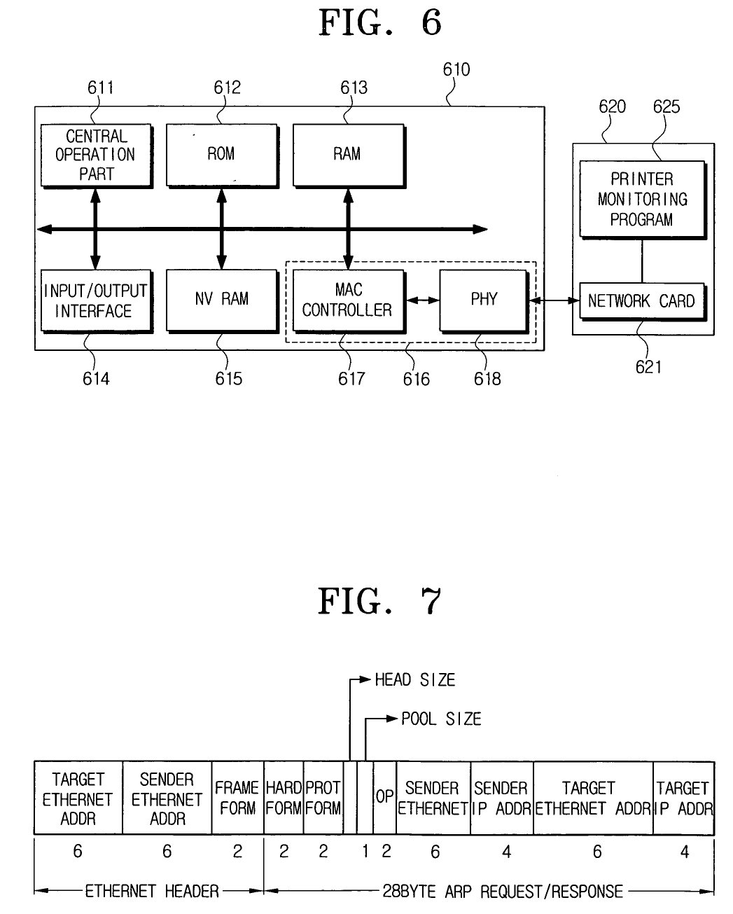

FIG. 8 is a flowchart illustrating a printing process of a printer in the network printer control system of FIG. 6; and

FIG. 9 is a flowchart illustrating a printer monitoring process of a terminal in the network printer control system of FIG. 6.

Throughout the drawings, it should be noted that the same or similar elements are denoted by like reference numerals.

### DETAILED DESCRIPTION OF THE PREFERRED EMBODIMENTS

Certain embodiments of the present invention will be described in greater detail with reference to the accompanying drawings.

The matters defined in the following description such as a detailed construction and elements are provided as examples. Thus, it should be apparent that the present invention can be performed without the described specific examples. Also, well-known functions or constructions are not described in detail since they would unnecessarily obscure the invention.

In an embodiment of the present invention, a network printer control system is provided. However, the present invention is not limited to the network printer, but may be applied to all kinds of peripheral devices which are connected to a network and are communicable with a terminal, for example, a facsimile machine, a scanner, a duplicator, etc. Also, the terminal is not limited to a computer, but may be a notebook connectable to a peripheral device by wire or wireless, a Personal Digital Assistant (PDA), a cellular phone, a digital video appliance having a digital camera, and so on.

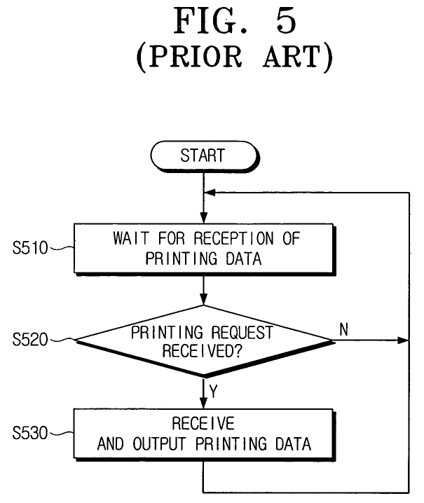

FIG. 6 is a block diagram illustrating the construction of a network printer control system according to an embodiment of the present invention.

The network printer control system according to an embodiment of the present invention includes a network printer 610 having a function of a network card integrated onto a board of the network printer, and a plurality of computers 620 that are terminals each having a built-in network card 621 and is communicable with the network printer 610 via a specified protocol.

The network printer 610 has a central operation part 611 for controlling the whole operation of the network printer 610, a Read Only Memory (ROM) 612 for storing a program required for an operation of the network printer 610 and a network protocol for data transmission and reception, a Random Access Memory (RAM) 613 for temporarily storing transmitted and received data and internal data, a Non-Volatile (NV) RAM 615 comprising a flash memory, a communication module 616 for transmitting and receiving data through a wire or wireless network, and an input/output interface 614 for interfacing the data transmitted and received between the central operation part 611 and the input/output device 614.

Here, the communication module 616 includes a Medium Access Control (MAC) controller 617 and a physical layer (PHY) 618. The MAC controller 617 makes it possible to transmit and receive the data, and limits the reception of a broadcast packet or a multicast packet under the control of the central operation part 611. The PHY 618 is a physical layer that converts an external LAN signal to a signal compatible with the computer 620.

The ARP packet transmitted to or received from the communication module 616 has an Ethernet header and an ARP request and response section. The Ethernet header includes an address of the target Ethernet, an address of a sender Ethernet, and a frame format. The MAC controller 617 can determine whether the ARP packet is a unicast packet, broadcast packet or multicast packet by analyzing the address of the target Ethernet recorded in the Ethernet header. Also, the MAC controller 617 limits or permits the reception of the broadcast packet or the multicast packet under the control of the central operation part 611.

The central operation part 611 detects an operation state of the network printer 610, and controls the communication module 616 according to the operation state, so as to limit or permit the reception of the broadcast packet or the multicast packet received in the network printer 610. Specifically, the central operation part 611 controls the MAC controller 617 to limit the reception of the broadcast packet and the multicast packet received in the network printer 610 while the network printer 610 performs a printing operation. If the network printer 610 completes the printing operation, the central operation part 611 releases the receiving limit by controlling the MAC controller 617, so that the reception of the broadcast packet and the multicast packet becomes possible.

Meanwhile, if the TCP/IP is used as the communication protocol, in order for one terminal to communicate with another terminal, the terminal broadcasts an ARP request packet to receive the MAC address of the opposite terminal. Also, if using a moving IP, the terminal generally broadcasts in order to determine the position of the server or its own position in the network.

However, if the reception of the broadcast packet and the multicast packet is limited while the network printer 610 performs the printing operation, an ARP response packet cannot be transmitted in response to the ARP request packet received in the form of a broadcast. Accordingly, the respective computer 620 may recognize neither the operation state of the network printer 610 nor the existence of the network printer 610. Accordingly, the central operation part 611 of the network printer 610 periodically broadcasts a packet for the operation state of the printer to the respective computer 610 by monitoring the operation state of the printer 610, and broadcasts the completion of the operation of the printer to the respective computer 620 even when the operation of the network printer 610 is completed.

Meanwhile, the respective computer 620 has a network card 621 and a printer monitoring program 625 installed therein. The printer monitoring program 625 detects the state of the network printer 610 by receiving the packet having the information on the operation state and the operation completion of the network printer 610 broadcast from the network printer 610.

The printer monitoring program 625 analyzes the packet including the information on the operation state broadcast from the network printer 610, and updates the information of the network printer including the MAC address and the IP address of the network printer 610 in the ARP cache table. Since the respective computer 620 periodically updates the MAC address and the IP address of the network printer 610 in the ARP cache table, it is not required for the respective computer 620 to broadcast the broadcast packet for receiving the MAC address of the network printer 610 during the next printing job. That is, the respective computer 620 directly transmits the printing data and the unicast packet for requesting the printing job to the network printer 610 using the MAC address stored in the ARP cache table.

The printer monitoring program 625 may inform the user of the state of the network printer 610 broadcast from the network printer 610 by displaying the state of the network printer 610 through a monitor, and the user can selectively set this through an environment setting of the printer monitoring program 625.

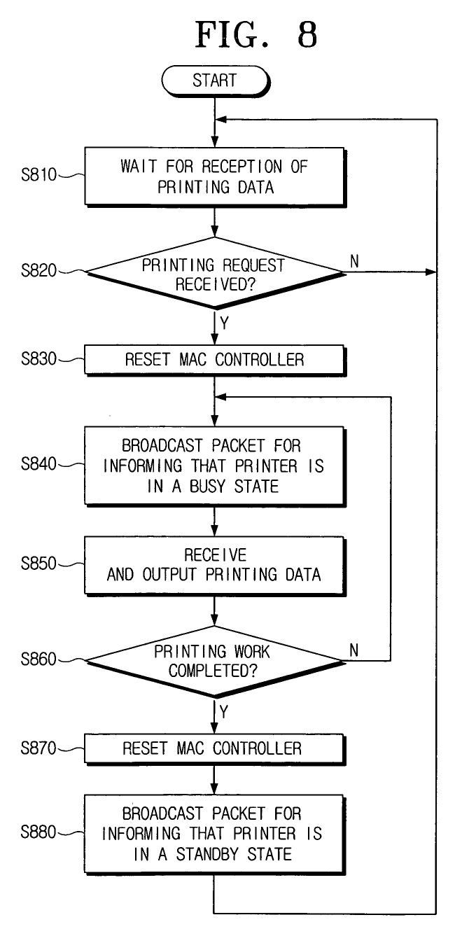

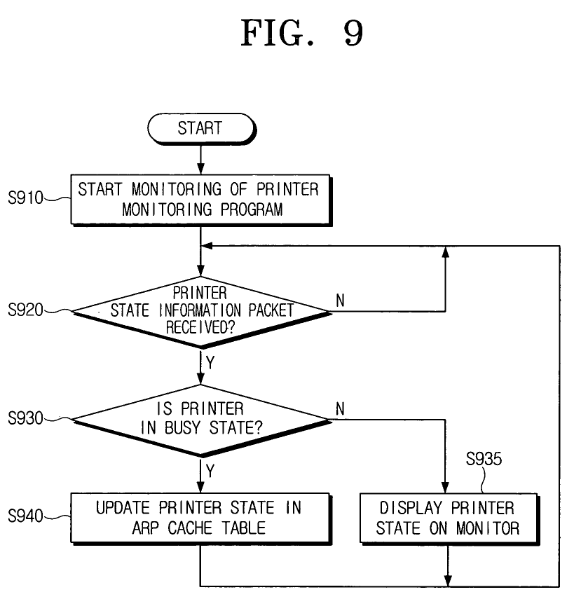

The operation performed by the network printer 610 and the computer 620 in the network printer control system as constructed above and will now be explained with reference to FIGS. 8 and 9.

First, if the printing data in the form of a unicast packet is received from a certain computer 620, the central operation part 611 of the network printer 610 waits for the reception of the printing data at step S810, and then checks if the printing request is received at step S820. If the printing request is received, the central operation part 611 sets the MAC controller 617 so that the reception of the broadcast packet and the multicast packet transmitted from the computer 620 is limited at step S830. That is, the central operation part 611 only permits the reception of the unicast packet that is transmitted with the network printer 610 designated among the packets transmitted from the respective computer 620.

As the central operation part 611 of the network printer 610 sets the MAC controller 617, receives the unicast packet, and performs the printing job, it periodically broadcasts the state information packet that indicates that the network printer 610 is now printing the job, e.g., in a busy state at step S840. The central operation part 611 broadcasts the state information packet to indicate the start of the printing operation to the respective computers 620 that attempt to use the network printer 610. This state information packet indicates that the network printer 610 cannot respond even if the ARP request packet is transmitted from the respective computer 620 to the network printer 610, and guides the IP address and the MAC address of the network printer 610 included in the state information packet to be stored in the ARP cache table of the respective computer 620.

The central operation part 611 continuously monitors whether the printing job is completed at step S860, and if the printing job is completed, the central operation part 611 restores the setting of the MAC controller 617 to permit again the reception of the broadcast packet and the multicast packet at step S870. Then, the central operation part 611 broadcasts the state information packet for indicating that the printing operation of the network printer 610 is completed and the network printer 610 is ready to perform the next printing job to the respective computers 620 at step S880.

If the printing job is not completed, the central operation part 611 broadcasts the state information packet for indicating that the network printer 610 is in a busy state to the respective computer 620. The central operation part 611 broadcasts the state information packet to indicate the working state of the network printer 610 to the computers 620 that failed to receive the previous state information packet, so that the ARP cache table can be updated.

Meanwhile, a data processing procedure performed by the respective computer 620 during the printing operation of the network printer 610 is illustrated in FIG. 9. The printer monitoring program 625 of the respective computer 620 monitors whether the state information packet is received from the network printer 610 at step S910. If the state information packet is received from the network printer 610 at step S920, the printer monitoring program 625 checks the operation state of the network printer 610 included in this packet. At this time, if it is determined that the state of the network printer 610 is busy at step S930, the printer monitoring program updates the IP address and the MAC address of the network printer 620 in the ARP cache table by analyzing the received packet at step S940. That is, the printer monitoring program 625 analyzes the state information packet periodically transmitted from the network printer 610, and if the network printer 610 is not in a busy state, e.g., if the network printer is ready for the printing job, the printer monitoring program indicates this to the user through the monitor of the computer 620 at step S935.

As described above, the network printer control system according to embodiments of the present invention limit the reception of the broadcast packet or the multicast packet that are not directly related to the printing job if the network printer 610 is performing the printing job. Accordingly, the time and load required for receiving and processing the broadcast packet or the multicast packet can be reduced, and the operation speed of the network printer 610 is increased, thereby improving the efficiency of the network printer 610. Also, the frequency of errors, which may occur during receiving and processing a large number of packets, can be reduced.

Meanwhile, by periodically broadcasting the state information packet for indicating the working state of the network printer 610 to the respective computer 620, the computer 620 can receive the MAC address for the network printer 610 even though a separate broadcast packet is transmitted. Accordingly, since the computer 620 does not have to transmit the broadcast packet in order to know the MAC address of the network printer 610, the time required for the pre-preparation of the printing can be reduced. Also, the respective computer 620 can reduce the load produced due to the transmission of the broadcast packet for grasping the MAC address of the network printer 610 can be reduced.

As described above, according to embodiments of the present invention, the time and load required for receiving and processing the broadcast packet and the multicast packet is reduced by limiting the reception of the broadcast packet or the multicast packet that are not directly related to the printing job in case that the network printer is at performing a job, and thus the working efficiency of the network printer can be improved. Also, the error occurrence can be prevented.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A network printer control system having at least one terminal and a network printer communicably connected to the terminal, comprising:
a communication module for transmitting and receiving data to and from the respective terminal through a wire or wireless network; and
a central operation part for controlling the communication module to limit reception of packets that satisfy a specified condition among data packets provided from the respective terminal to the network printer during a printing job of the network printer according to a request from the terminal.

2. The network printer control system as claimed in claim 1, wherein the central operation part controls the communication module to limit reception of at least one of a multicast packet and a broadcast packet transmitted from the respective terminal during the printing job.

3. The network printer control system as claimed in claim 1, wherein the communication module comprises a MAC controller for controlling the multicast packet and the broadcast packet transmitted to and received from the respective terminal.

4. The network printer control system as claimed in claim 3, wherein the central operation part broadcasts operation state information on whether the network printer is performing the printing job to the respective terminal at predetermined intervals.

5. The network printer control system as claimed in claim 3, wherein if the printing job is completed, the central operation part indicates completion of the printing job to the respective terminal, and releases the receiving limit of the broadcast packet and the multicast packet by resetting the MAC controller.

6. The network printer control system as claimed in claim 3, wherein the terminal is provided with a printer monitoring program for monitoring whether the operation state information is provided from the network printer.

7. The network printer control system as claimed in claim 6, wherein the printer monitoring program updates an address resolution protocol (ARP) cache table by extracting a MAC address and an IP address of the network printer from the operation state information provided from the network printer.

8. A data reception control method in a network printer control system including at least one terminal, a communication module for transmitting and receiving data to and from the respective terminal through a wire or wireless network, and a network printer having a central operation part for controlling the communication module and a whole operation of the system, the method comprising the steps of:
detecting whether the terminal requests a print job to the network printer;
performing the job by operating the network printer if the terminal requests the print job; and
setting the communication module to limit reception of packets that satisfy a specified condition among data packets provided from the terminal to the network printer.

9. The data reception control method as claimed in claim 8, wherein the step of limiting the reception of the packets limits the reception of at least one of a multicast packet and a broadcast packet transmitted to the network printer.

10. The data reception control method as claimed in claim 8, further comprising:
providing operation state information on whether the network printer is performing the printing job to the terminal at predetermined intervals.

11. The data reception control method as claimed in claim 8, further comprising:
indicating completion of the print job of the network computer to the respective terminal if the print job is completed; and
controlling the communication module to release the receiving limit of the broadcast packet and the multicast packet.

12. The data reception control method as claimed in claim 8, further comprising:
monitoring whether the operation state information is provided from the network printer.

13. The data reception control method as claimed in claim 8, further comprising:
updating a MAC address and an IP address of the network printer included in the operation state information provided from the network printer in an address resolution protocol (ARP) cache table of the terminal.
